(19) United States
(12) Patent Application Publication
(10) Pub. No.: US 2010/0323865 A1
(43) Pub. Date: Dec. 23, 2010

(54) CONTAINER CONSTRUCTION WITH SELECTABLE VOLUME

(76) Inventor: George Zeiler, Olathe, KS (US)

Correspondence Address: HUSCH BLACKWELL LLP, 4801 Main Street, Suite 1000, KANSAS CITY, MO, 64112, US

(21) Appl. No.: 12/870,961

(22) Filed: Aug. 30, 2010

Related U.S. Application Data
(62) Division of application No. 11/567,855, filed on Dec. 7, 2006.

(51) Int. Cl. B31B 49/02

(52) U.S. Cl. 493/84

(57) ABSTRACT

A container is provided including a receptacle with a seamed container sidewall and bottom member secured thereto. The container includes a lid. The bottom member is selected to provide a desired container volume with the bottom member having an inner convex surface. A plurality of differently contoured bottom members may be provided to permit selection of a container volume by selecting a container bottom member.

### BACKGROUND OF THE INVENTION

The manufacture of various containers is well known in the industry. One type of container is referred to in the art as a convolute container. It includes a wrapped container sidewall having a side seam that preferably extends generally longitudinally between opposite ends of the container bottom or receptacle. Typically such containers are made from a paperboard material or plastic sheet wherein the seam is formed by overlapping end edge margin portions of a blank that are suitably secured together. Such containers are very effective in function and are relatively inexpensive to manufacture. However, they do have their deficiencies.

Providing a different storage volume of container has traditionally been accomplished by changing a wrapping mandrel to change the diameter of the container receptacle (or the cross sectional size of the receptacle in the event the receptacle is frustoconical or oval instead of generally cylindrical). Another way of providing a different volume is to change the height of the receptacle sidewall. Effecting a volumetric change in a container has required changing in tooling or tooling setup which requires down time and labor. The change in container volume by traditional approaches may also require a change in the shipping containers. In view of the usually low margins in the container industry, both of the above container changes can adversely affect profitability. It would be desirable to provide a container construction that would permit changes of interior volume of a container with a standard sidewall in a simple and effective manner.

The volume change in a container receptacle may be necessitated by a change in the density of the product as for example ice cream which may have varying degrees of overrun. There is thus a need for a container construction which would permit for easy change in the interior chamber volume without a change in the construction of the container sidewall and/or tooling and/or set up.

### SUMMARY OF THE INVENTION

The present invention involves the provision of a container construction and method of producing a container that provides a container receptacle with an easily changed interior volume for the stored contents. A container receptacle includes a bottom member secured to a sidewall with the sidewall having an open end providing access to an interior of the receptacle. The sidewall may be of a convolute form. The receptacle includes a bottom member that is made separately from the sidewall and then is secured thereto. The bottom member has a convex inner surface projecting into the storage compartment of the receptacle. An outer surface of the bottom member is preferably concave and generally corresponds to the shape of the inner surface providing a generally uniform thickness. An outer perimeter portion of the bottom member is secured to the container sidewall to close the bottom of the receptacle. By being convex, a portion of the volume of the container compartment, is occupied by the bottom member. The shape of the bottom member is selected to provide the desired interior volume for the container. A series of bottom members may be made each having a different interior surface contour to provide a desired interior compartment volume. Thus, by proper selection of the bottom member from a series of different bottom members, a desired compartment volume can be provided in a container utilizing a standard sidewall. A lid may be provided of various designs that may have a depending skirt for frictional fit with an upper portion of the receptacle sidewall. The lid may also include a closure panel secured to the skirt and extending across an inner perimeter portion of the skirt.

The present invention involves the provision of a method for making a container. The method includes the formation of a container receptacle sidewall. The sidewall has opposite ends both of which are open with one open end providing a container opening and the other open end providing an area for securement of a bottom member to the sidewall. In a preferred embodiment, the sidewall is formed by wrapping a cut blank of sheet material on a mandrel and forming a longitudinally extending seam. A skirt may be formed at one of the open ends to overlie an outer surface portion of a bottom member. The bottom member is formed preferably of a polymeric material and is then positioned adjacent to a bottom portion of the container sidewall and then secured thereto. The skirt may be formed before or after placement of the bottom member into the foamed sidewall. A lid is formed and may be placed on the container after the container is filled with product.

### BRIEF DESCRIPTION OF THE DRAWINGS

FIG. 1 is an exploded perspective view of a container comprising the present invention.

FIG. 2 is an enlarged fragmentary sectional view of a portion of the container lid.

FIG. 3 is an enlarged fragmentary sectional view of a portion of the container receptacle showing details of the bottom member and sidewall.

FIG. 4 is an enlarged fragmentary perspective view of a portion of the bottom member and sidewall showing details of the construction thereof.

FIG. 5 is an enlarged schematic illustration of a lower portion of the receptacle showing various bottom member contours.

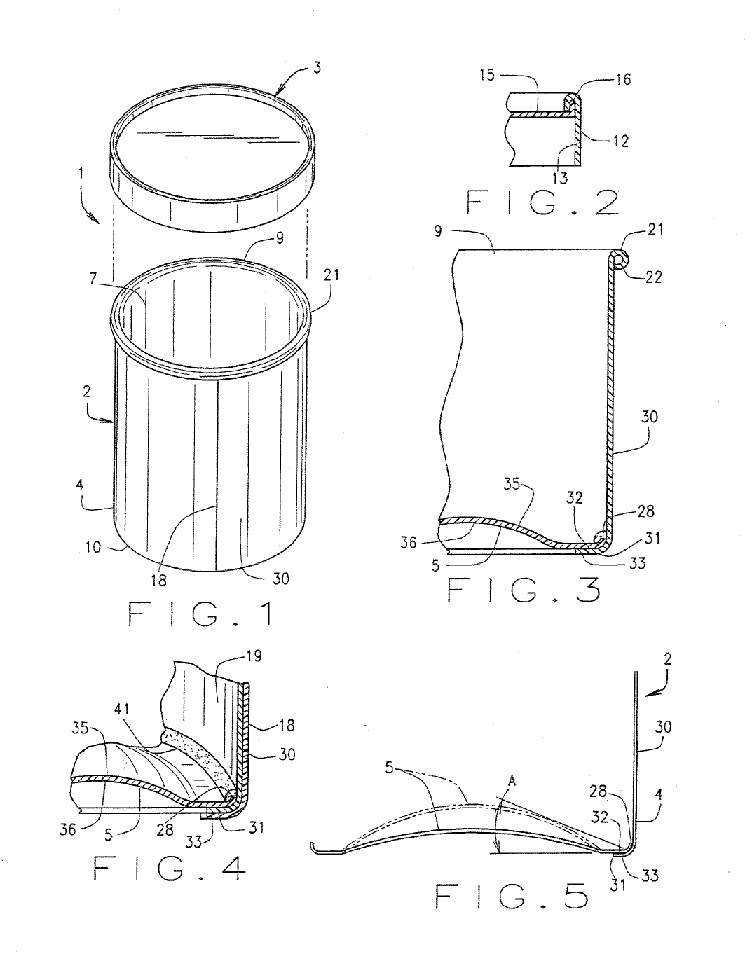

Like numbers throughout the various Figures designate like or similar parts or construction.

### DETAILED DESCRIPTION

The present invention involves a container designated generally 1. The container 1 includes a lid or cover 3 and a receptacle 2 which includes a sidewall 4 and a bottom member 5. The bottom member 5 and sidewall 4 define a storage compartment 7 that is accessible through an open end 9. The bottom member 5 covers and closes an end 10 of the compartment 7 and is opposite to the open end 9. The closed end 10 is typically the end that is on the bottom during use and storage of the container 1 and may be referred to for clarity as the bottom end and the end 9 as a top end. The receptacle 2 may have any suitable transverse cross sectional shape such as oval or round and the sidewall 4 may be generally cylindrical or frustoconical in shape as desired. Generally, the open end 9 is at least as large as the remainder of the transverse cross sectional size of the remainder of the sidewall between the open top end 9 and the bottom end 10.

The lid 3 may be any suitable lid and is adapted for securement to the receptacle 2 adjacent the open end 9. The lid 3 may be a snap lock type lid or, as shown, may be a friction fit lid. The illustrated lid 3 has a depending skirt 12 having an interior surface 13 sized and shaped to engage an outer perimeter portion of the receptacle 2 to selectively close the open end 9. The lid 3 also includes a closure panel 15 that in a preferred embodiment is connected to the skirt 12 as at a joint 16. In a preferred embodiment, the lid 3 is formed of paperboard with a joinder of the panel 15 to the skirt 12 being a combination of a mechanical interlock and adhesive, heat seal or the like. Preferably, the material comprising the lid 3 is coated to prevent the ingress of liquid such as water and/or lipids (fats and oils) into the paperboard. The panel 15 may be used for printing of indicia to indicate the product brand and other information regarding the contents of the container. The lid 3 may be paperboard, may be molded of polymeric material or made by forming from polymeric sheet material or combinations thereof.

The sidewall 4 is preferably made from a cut blank of material, preferably paperboard that is coated to resist penetration by liquids such as water and/or lipids. Paperboard is preferably coated with a moisture resistant material like low density polyethylene which can be used in forming a side seam 18 as by heat sealing. The sidewall may also be formed from a suitable sheet of polymeric material. The sidewall 4 is preferably of a convolute form having a generally longitudinally extending side seam 18 extending between opposite ends of the sidewall 4. The sidewall 4 may also be helically wrapped providing a helical seam 18 if desired. In the illustrated embodiment, the open end 9 has an inner perimeter that is preferably at least as large as the inner perimeter of the remainder of the interior surface 19 extending from the open top end 9 to the closed bottom end 10. The sidewall 4 includes a side panel 30. When the container sidewall 4 side panel 30 is frustoconical, the open end 9 is larger than the transverse cross section of the remainder of the compartment 7. When the sidewall 4 side panel 30 is generally cylindrical, the open end 9 is generally the same size and shape of the remainder of the transverse cross sectional shape of the compartment 7. The transverse cross sectional shape of the sidewall 4 may also be oval or any other suitable shape. The illustrated receptacle 2 is provided with an outwardly projecting lip 21 positioned at the open end 9. The lip 21 can be in the form of a rim curl or top curl. The outer perimeter portion 22 of the lip 21 is positioned outwardly of an outer surface 24 of the sidewall 4. The outer perimeter size and shape of the portion 22 conforms generally to the size and shape of the perimeter of the interior of the lid 3 as defined by the surface 13. The illustrated structure provides a frictional mount of the lid 3 to the receptacle 2 by interengagement between the skirt 12 and lip 21

The bottom member 5 is made as a part separate from the container sidewall 4 and is suitably attached thereto. In the illustrated structure, the bottom member 5 has an outer perimeter portion 28 positioned adjacent a corner between the side panel 30 and a skirt 31 of the sidewall 4 which is in the form of an inturned flange. The skirt 31 has inner and outer surfaces 32, 33 respectively with the inner surface 32 facing generally toward the open end 9. When formed of paperboard, the inturning of the skirt 31 may produce puckers or folds in the skirt 31 to accommodate the excess material. The bottom member 5 has an inner convex surface 35 projecting into the compartments 7 whereby the bottom member 5 occupies a portion of the volume in the compartment 7 as compared to a flat or planar bottom member. Preferably, the bottom member 5 has an outer surface 36 that is concave corresponding generally in shape to the inner surface 35. A portion of the outer surface 36 overlies the surface 32 at the outer perimeter portion 28. The bottom member 5 is suitably attached to the sidewall 4. In the illustrated structure, the joinder may be at the interface between the outer edge portion 28 of the bottom member 5 at an inner surface of the sidewall 4 adjacent the bend between the panel 30 and skirt 31. A hot melt adhesive, heat seal or the like may be used to effect the attachment. In another embodiment, adhesive may be applied to the surface 32 or the surface 36 to form the attachment between the skirt 31 and the bottom member 5.

The contour of the inner surface 35 is selected to provide the desired volume in the compartment 7. The surface 35 is convex and has an angle A from a plane defined by the outer surface 33 of less than about 30° and preferably in the range of between about 5° and about 30°. It is to be noted that the surface 35 may be curved and the angle A would be that measured by a line tangent to the surface. Preferably, at least a majority of the surface area of the surface 35 is convex and within the just described angle A values. A family of differently contoured bottom members 5 may be made to provide for customizing a container 1 to provide different but desired volumes in the compartment 7 as is needed. Preferably, the bottom member 5 is made of a polymeric material which may be formed as for example by vacuum forming, thermoforming or the like. The outer perimeter shape of the bottom member 5 corresponds to the inside shape of the compartment 7 adjacent the skirt 31 or closed end 10.

The present invention is better understood by description of the method of manufacture. The lid 3 is suitable formed as by injection molding, vacuum forming or mandrel forming of the skirt 12 and joining the skirt to the panel 15 as by rolling an upper portion of the skirt onto and over a lip portion of the panel 15. This is well known in the art.

The sidewall 4 is suitably formed as is known in the art by e.g., wrapping a formed blank sidewall precursor about a mandrel. The formed blank is wrapped about a mandrel with the overlapping portions at the side edges being joined together, as by heat sealing, ultrasonic welding and adhesive joining, to form the side seam 18. After formation of the seam 18, the lip 21 is suitably formed as by rolling or crimping as are well known in the art. The skirt 31 may then be formed or alternately, it may be formed after positioning of the bottom member 5 in the compartment 7. The bottom member 5 is inserted into the compartment 7 from either of the ends 9 or 10 of the precursor to the receptacle 2. The convex side of the bottom 5 is positioned facing toward the open end 10. The concave side is positioned facing the end 10. The bottom member 5 is secured to the panel 30 in any suitable manner as for example by applying an adhesive at the abutting areas 41 at the outer edge of the bottom member 5 and the inside surface of the panel 30. Alternately, the flange 31 may be secured to the bottom member 5 or may also be secured to the bottom member 5 in addition to the adhesive securement at 41.

Depending upon the product to be placed in the compartment 7, an appropriate bottom member 5 is selected from a series of differently contoured bottom members 5. The selection is based on the desired volume of the compartment 7. The less volume desired for the compartment 7, the greater the convex curvature of the bottom member 5. A simple calculation can be utilized to determine which particular bottom member 5 to select and utilize. After the selection, the appropriate bottom members 5 are each secured to a respective sidewall 4 to form the respective 2. Preferably, the skirt 31 is formed prior to attachment of the bottom member 5 to accommodate for spring back of the skirt 31 if an inner positioned portion of skirt 31 is not secured to the bottom member 5.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1-18. (canceled)

19. A method of making a food container comprising:
forming a sidewall having opposite open end portions;
forming an inturned skirt at one said end portion whereby the skirt has an inner surface generally facing the other said end portion;
forming a bottom member separate from the sidewall, said formed bottom member having generally opposing first and second surfaces, said first surface having at least a majority thereof being generally convex;
positioning an outer perimeter portion of the second surface adjacent the inner surface to provide overlapping surfaces; and
joining the bottom member to the sidewall adjacent the skirt.

20. The method of claim 19 including forming a seam in the sidewall by overlapping side margin portions of a side panel and joining the side margin portions together.

21. The method of claim 20 wherein the bottom member is joined to the sidewall by adhesion.

22. The method of claim 21 wherein bottom member is positioned adjacent an end portion of the sidewall and then the skirt is formed.

23. The method of claim 19 including forming a plurality of first bottom members having a first convex contour and a plurality of second bottom members with a second convex contour each adapted to be secured to a respective said sidewall of a plurality of commonly sized and shaped sidewalls.

24. The method of claim 23 including selecting one of the first bottom members or second bottom members and joining them each to a respective sidewall, said selecting being based on desired container volume.
